(19) United States
(12) Patent Application Publication
(10) Pub. No.: US 2003/0232905 A1
(43) Pub. Date: Dec. 18, 2003

(54) Pressure sensitive adhesive compositions

(76) Inventors: Christopher L. Ives, Cheshire (GB); Ian Philip Middleton, Chester (GB); David M Lucas, Cheshire (GB); David Riley, Chester (GB)

Correspondence Address: Thomas Q Henry, Woodard Emhardt Naughton Moriarty & McNett, 111 Monument Circle, Bank One Tower Suite 3700, Indianapolis, IN, 46204, US

(21) Appl. No.: 10/240,969

(22) PCT Filed: Apr. 5, 2001
(86) PCT No.: PCT/GB01/01508

(30) Foreign Application Priority Data
Jun. 4, 2000 (GB) 0008328.7

(51) Int. Cl. C08L 1/00

(52) U.S. Cl. 524/35; 524/505

(57) ABSTRACT

A pressure sensitive adhesive composition comprises a poly-α-olefin, a poly-iso-butylene and a compatibilising high surface area stabiliser. The composition exhibits good cold flow and adhesive properties with a high resilience to γ-radiation. A method of preparing the pressure sensitive adhesive composition is also described.

The present invention relates to pressure sensitive adhesive compositions and methods for producing such compositions.

Typically pressure sensitive adhesives (PSAs) incorporate poly-iso-butylene (PIB). PIB is especially suitable in this application as it is inexpensive, is adhesive and has a good combination of flow properties, namely it has a good viscosity and a limited cold flow which enables it to overcome imperfections in surfaces to which it is applied. This last property, together with their non-toxic nature have made PSAs based on PIB useful in several medical applications, such as hydrocolloid wound dressings. For example U.S. Pat. No. 33,395,469 discloses hydrocolloid compositions based upon poly-iso-butylene (PIB) with a variety of water soluble and water swellable polymers used as pressure sensitive adhesives for medical applications.

Typically PSAs contain a blend of low and medium molecular weight PIB. Low molecular weight PIB has high cold flow and low viscosity, whereas medium molecular weight PIB has lower cold flow and higher viscosity. The blend of low and medium molecular weight PIBs allows the desirable combination of cold flow and adhesion properties to be obtained.

One of the problems of using PIB as a PSA is that γ-radiation (a commonly used sterilisation technique necessary for most medical applications) can cause scission of the PIB molecules, leading to a lower molecular weight polymer. The medium molecular weight PIB generally present in the formulation has a higher resilience to γ-radiation than low molecular weight PIB and therefore acts as an aid to the γ-radiation stability of the formulation. However, this stability is still undesirably affected.

This lowering of the molecular weight of PIB on γ-radiation causes its cold flow to increase, its viscosity to decrease and consequently its desirability as a PSA is greatly reduced. As an illustration of the effect of the γ-radiation, low molecular weight PIB has been observed to be converted from a viscous gel to a mobile fluid.

The problem of stability to γ-radiation of PSAs has already been addressed. For example WO-A-98/54268 discloses a PSA in which the PIB in the adhesive is replaced by a poly-α-olefin, which is more resilient to γ-radiation.

An α-olefin is an unsaturated hydrocarbon having at least one carbon-carbon double bond, wherein that bond is positioned such that it is terminal in the molecule concerned. A poly-α-olefin is a polymer of such a compound. Poly-α-olefins are prepared by Ziegler-Natta polymerisation of α-olefins, for a discussion of their preparation see J.Boor in “Zeigler-Natta catalysts and polymerizations” Chapter 19 Academic Press N.Y. 1979, and (particularly when in the form a block copolymer of ethylene and propene, butene, pentene or hexene) lend themselves to PSAs as they are naturally tacky, exhibit low toxicity and have good ageing properties. U.S. Pat. No. 3,653,755 describes poly-α-olefin PSAs that may be used as surgical tapes. Eastman (who have introduced a range of amorphous poly-α-olefin materials) have described how an ethylene-propylene amorphous poly-α-olefin (Eastoflex E-1003) may be used as a replacement for PIB in hot-melt sealants (Eastman Publication WA-60) and pressure sensitive adhesives (Eastman Publication WA-52) to produce formulations with improved weathering and oxygen/ozone resistance.

However, a problem with poly-α-olefin PSA compositions is that they do not display the desirable cold flow and viscosity properties of PIB. These properties must be supplemented by the addition of various property enhancers such as plasticisers, some of which have potential to cause allergenic side effects.

A further problem with these compositions (as described in U.S. Pat. No. 5,859,088) is that a PSA based upon a poly-α-olefins composition is not as effective an adhesive when compared to a PSA based on PIB. This poor adhesive property is sometimes referred to as “legging” of the adhesive whereby a residue of adhesive is retained on the skin surface after removal. In the case of poly-α-olefins this often results in a “waxy” feel of adhesive being retained on the skin.

In examples where the ethylene-propylene poly-α-olefin Eastoflex E-1003 is used to replace PIB another polymeric component, usually a styrene block copolymer elastomer, is present to provide cohesive strength to the adhesive composition. Such block co-polymers (styrene-isoprene-styrene, styrene-butadiene-styrene, styrene-ethylene-butylene-styrene) have long been known and used in conjunction with PIB to produce hydrocolloid PSAs with superior properties. Details of such compositions are contained in U.S. Pat. No. 4,551,496. The inclusion of these types of block co-polymers does however reduce the viscosity of the composition. The lowering of viscosity effect means that a higher molecular mass poly-α-olefin must be employed or a tackifying resin must be added to the composition.

The requirement for additives, in the poly-α-olefin PSA composition, increases its complexity and leads to a more difficult manufacturing process, such as the need for high mixing temperatures, with associated higher manufacturing costs and possible problems in the case where the PSA incorporates a temperature sensitive additive, e.g. a pharmaceutical. For example data sheet publication WA-52 of Eastman describes a PSA mixing process wherein the mixing of the E-1003 formulation is carried out at 177° C., a temperature that would cause decomposition of most pharmaceuticals. Thus the benefits of using a different base to PIB are somewhat negated.

In order to have the radiation stability of a poly-α-olefin PSA with the beneficial properties of PIB the use of a mixture of PIB with a poly-α-olefin could be been contemplated. However, as disclosed in WO-A-98/54268, these formulations have been dismissed for the reason that poly-α-olefins and PIB are reported to be incompatible (particularly when lower mixing temperatures of 90-130° C. are required), that is to say that they will not form a homogeneous PSA formulation, but rather a combination of several phases (e.g. an emulsion).

It is an object of the present invention to obviate or mitigate the abovementioned disadvantages.

According to a first aspect of the present invention there is provided a pressure sensitive adhesive composition comprising a poly-α-olefin, a poly-iso-butylene and a compatibilising high surface area stabiliser.

We have found that pressure sensitive adhesive (hereafter referred to as PSA) compositions with excellent cold flow, viscosity and γ-radiation stability properties may be obtained by the use of a poly-α-olefin and a poly-iso-butylene (hereafter referred to as PIB) composition provided these individual components are compatiblised by the use of a high surface area stabiliser, which is also an aid to the structural integrity of the PSA. The composition is notably simpler, both in the number of ingredients required and in the manufacturing process to fabricate the PSA, compared to earlier poly-α-olefin based PSAs.

It has been found that the use of a high surface area stabiliser not only aids the structural integrity of the PSA, obviating the need for a styrene block copolymer or similar strengthening polymer, but also enables the polymeric components to be mixed at a lower temperature thus simplifying the fabrication process.

It is most preferred that the high area stabiliser is insoluble in components of the PSA composition. It is preferred that the insolubility of the high surface area stabiliser be retained over the duration and conditions of the fabrication process, wherein no appreciable agglomeration of the stabiliser should occur.

The high surface area stabiliser may be hydrophobic or hydrophilic (water swellable) in nature.

It is preferred that the high surface area stabiliser is a fibrous material.

The fibrous material is preferably in the form of a single fibre strands. It is preferred that the fibrous material has a high surface area per unit mass ie low bulk density. Most preferably the surface area of the fibrous material is such that one gram of the material occupies 2-15 cm³, most preferably 3-10 cm³. The fibre strands preferably have a length of 30-250 μm, most preferably 50-150 μm and a cross-section of 5-25 μm.

Preferred examples of fibrous material include cellulosic fibres, such as Justfiber (available from International Filler of Belgium).

It is preferred that the fibrous material constitutes from 10-60% of the weight of the composition. More preferably the fibrous material constitutes from 15-55% by weight of the composition and even more preferably 20-50% by weight.

Alternatively the high surface area stabiliser may comprise particulate material.

The particulate material preferably has a particle size in the range of 10-500 μm, most preferably 30-100 μm.

Preferred particulate materials include silica such as Hi-sil 233 (available from PPG Industries, Pittsburgh, USA) and micro-crystalline cellulose such as Avicel PH101 (available from FMC, Philadelphia, USA).

A mixture of fibrous and particulate high surface area material may be used in the composition.

It is preferred that the particulate material constitutes from 20-40% of the weight of the composition. More preferably the particulate material constitutes from 30-40% of the weight of the composition.

Preferably the mean molecular mass of the PIB is 150,000 to 250,000. (The molecular masses of the PIB as quoted herein are number average molecular weights (Mn)). This mean molecular mass figure may be obtained from a single PIB polymer or from of a mixture of different PIB polymers. Generally a mixture of medium and low molecular mass PIB will be used to reach the desired composition. In this way the cold flow properties and the resistance to γ-radiation may be optimised. It is understood that medium molecular mass PIB has a molecular mass in the range of 700,000 to 900,000 and low molecular mass PIB has a molecular mass in the range of 40,000 to 100,000. Generally the amount of low molecular mass PIB will be between 70-95% by weight of the PIB content and the proportion of medium molecular mass PIB will be in the range of 5-30% of the PIB content.

A preferred example of a low molecular mass PIB is Vistanex LMMH (available from Exxon). A preferred example of a medium molecular mass PIB is Vistanex L-80 (available from Exxon).

It is preferred that the PIB constitutes from 40-65% of the weight of the composition. More preferably the PIB constitutes from 50-60% of the weight of the composition.

It is proposed that the presence of poly-α-olefin in the PSA is an aid to the structural stability of the PSA, providing control of the cold flow properties of the composition. It is also proposed that the presence of poly-α-olefin in the PSA causes a lowering of the γ-radiation induced scission of the PIB.

Preferred poly-α-olefins (hereafter referred to as PA) are polymers composed of one or more of ethene, propylene, but-1-ene, pent-1-ene and hex-1-ene.

Where more than one α-olefin is used the resultant co-polymers may be block, random or alternating co-polymers. It is preferred that the poly-α-olefin is a block co-polymer, most preferably a block-copolymer of ethene with one or more of the other monomers set out in the preceding paragraph. Preferably the poly-α-olefin is a block copolymer of ethene and propene.

It is preferred that the PA constitutes from 5-25% of the weight of the composition. More preferably the PA constitutes from 10-20% of the weight of the composition.

The preferred poly-α-olefin is Eastoflex E-1003 (available from Eastman), a amorphous polymer of ethylene and propylene. Eastoflex E-1003 has a glass transition temperature of −33° C., a Brookfield viscosity of 250 centi-poise at 190° C. and a ring and ball softening point of 120° C. The tensile strength of the material is typically 0.07 MPa and elongation at break is typically 35%.

Eastoflex E-1003 has desirable cold flow properties that are suited to a PSA according to the invention.

The composition may also contain an extender. The extender preferably constitutes from 2-5% of the composition by weight. A preferred example of an extender is a mineral oil.

A pressure sensitive adhesive composition produced from the abovementioned components, i.e. PIB, PA and high surface area stabiliser comprising fibrous/particulate material, may have the following composition.

| | |
|---|---|
| Low molecular weight PIB | 20-50 wt % |
| High molecular weight PIB | 10-20 wt % |
| PA | 10-20 wt % |
| High surface area stabiliser | 20-50 wt % |

The PSA may incorporate additives depending on the intended use of the PSA. Examples of such additives include:

(1) Pharmaceuticals.

(2) Emollients.

(3) Vitamins.

(4) Herbal extracts

(5) Water soluble polymers, such as polysaccharides, including gelatin, pectin and carboxymethyl cellulose.

(6) Anti-bacterial agent.

Where there are other additives used it is preferred that they are present attached to the high surface area stabiliser. Alternatively the additives can be free in solution/suspension.

The pressure sensitive adhesive is intended to be used as a general pressure sensitive adhesive. In this case silica is preferred as the high surface area stabiliser. In applications wherein a high degree of water content is deleterious to the performance of the PSA, egs a PSA for an active agent that may be water sensitive or where long term adhesion to skin in a wet environment is desirable, it is desirable to have a hydrophobic matrix such as one where silica is used as the stabiliser. Alternatively the pressure sensitive adhesive is intended to be used as a hydrocolloid pressure sensitive adhesive. In this case a water swellable high surface area stabiliser, such as cellulose is preferred. It is recognised that a PSA may comprise a mixture of hydrophilic and hydrophobic components so that the water swellable properties may be tailored to the exact requirement. Preferably the PSA composition is used as an adhesive in the following applications:

(1) Transdermal drug delivery.

(2) Attachment devices for ostomy/stoma bags.

(3) Wound dressings.

The PSA may be prepared by admixing the poly-α-olefin, the poly-iso-butylene the high surface area stabiliser, and any other component of the formulation.

Preferably the method of preparation is carried out at about the softening temperature of the poly-α-olefin.

The pressure sensitive adhesive may be produced simply by adding the specific components as separate additions to an appropriate mixing device and thoroughly mixing. Any mixer that is capable of breaking down a mixture of a viscoeleastic solid at 90-130° C. would be suitable. Preferred examples of mixing devices that can be used include Z-blade mixers. The mixing step is preferably effected for 20-30 minutes following the addition of each ingredient and finally for about 1 hour after all the ingredients have been added.(See Examples)

The inclusion of a coloured material in the formulation greatly assists in observation of mixing and compatibility of the PIB and poly-α-olefin phases of the PSA composition. Certain anti-bacterial materials are coloured and thus facilitate preparation of the PSA for applications such as wound dressings.

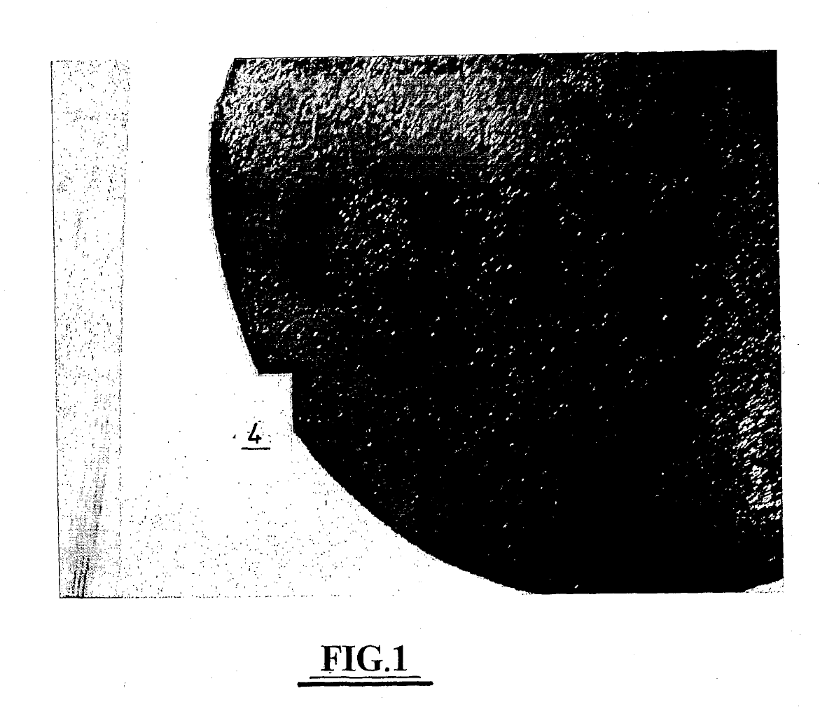

The invention will be further illustrated by the following, non-limiting Examples and accompanying FIGS. 1 to 5 which illustrate results of the Examples.

### EXAMPLE 1

Preparation of the following composition was carried out.

| | Ingredient | % w/w |
|---|---|---|
| 1 | Vistanex LMMH | 30 |
| 2 | Vistanex L80 | 15 |
| 3 | Eastoflex E-1003 | 20 |
| 4 | Avicel PH101 | 30 |
| 5 | Whitemoor WOM14 | 5 |

Where

Vistanex LMMH is a low molecular weight PIB.

Vistanex L80 is a medium molecular weight PIB.

Eastoflex E-1003 is an amorphous ethylene-propylene poly-α-olefin.

Avicel PH101 is a micro-crystalline cellulose particle.

Whitemoor WOM14 is a mineral oil.

A twin Z-blade mixer (model 2Z, Winkworth Machinery Ltd) was pre-heated by an oil jacket to 100° C. and the blades coated with 10-15% total weight of the Avicel PH101 in the mix.

The ingredients were added sequentially in the order cited above with 20-25 minutes mixing time being allowed prior to the next addition. After the addition of the final ingredient a further mixing time of 1 hour was employed before the mixture was ejected from the Z-blade mixer.

Portions of the mixture were pressed between pieces of siliconised paper at 110° C. to produce samples of 1 mm thickness. The material was found to have good cohesive strength and to adhere well to skin, being easily removed by peeling, leaving no residue on the skin surface.

### EXAMPLE 2

In an identical manner to that described in Example 1 above, the following mixture was mixed in a Z-blade mixer at 100° C.

| | Ingredient | % w/w |
|---|---|---|
| 1 | Vistanex LMMH | 45 |
| 2 | Vistanex L80 | 15 |
| 3 | Eastoflex E-1003 | 20 |
| 4 | Hi-sil H233 | 20 |

Hi-sil H233 is a silica particle.

1 mm samples of this material were found to have good cohesive strength and to adhere well to skin, being easily removed by peeling, leaving no residue on the skin surface.

### EXAMPLE 3

In an identical manner to that described in Example 1 above, the following mixture was mixed in a Z-blade mixer at 100° C.

| | Ingredient | % w/w |
|---|---|---|
| 1 | Vistanex LMMH | 38 |
| 2 | Vistanex L80 | 5 |
| 3 | Eastoflex E-1003 | 5 |
| 4 | Justfiber C40 | 50 |
| 5 | Whitemoor WOM14 | 2 |

Justfiber C40 is a cellulose fibre.

1 mm samples of this material were found to have good cohesive strength and to adhere well to skin, being easily removed by peeling, leaving no residue on the skin surface.

### EXAMPLE 4

In an identical manner to that described in Example 1 above, the following mixture was mixed in a Z-Blade mixer at 100° C.

| | Ingredient | % w/w |
|---|---|---|
| 1 | Vistanex LMMH | 33 |
| 2 | Vistanex L80 | 16 |
| 3 | Eastoflex E-1003 | 16 |
| 4 | Avicel PH101 | 33 |
| 5 | Whitemoor WOM14 | 2 |

1 mm samples of this material were found to have good cohesive strength and to adhere well to skin, being easily removed by peeling, leaving no residue on the skin surface.

### EXAMPLE 5

In an identical manner to that described in Example 1 above, the following mixture was mixed in a Z-blade mixer at 100° C.

| | Ingredient | % w/w |
|---|---|---|
| 1 | Vistanex LMMH | 40 |
| 2 | Vistanex L80 | 10 |
| 3 | Eastoflex E-1003 | 12 |
| 4 | Hi-sil H233 | 35 |
| 5 | Whitemoor WOM14 | 3 |

1 mm samples of this material were found to have good cohesive strength and to adhere well to skin, being easily removed by peeling, leaving no residue on the skin surface.

### EXAMPLE 6

In an identical manner to that described in Example 1 above, the following mixture was mixed in a Z-blade mixer at 100° C.

| | Ingredient | % w/w |
|---|---|---|
| 1 | Vistanex LMMH | 45 |
| 2 | Vistanex L80 | 15 |
| 3 | Eastoflex E-1003 | 20 |
| 4 | Avicel PH101 | 20 |

1 mm samples of this material were found to have good cohesive strength and to adhere well to skin, being easily removed by peeling, leaving no residue on the skin surface.

### Comparative Example 1

In an identical manner to that described in Example 1 above, the following mixture was mixed in a Z-blade mixer at 100° C.

| | Ingredient | % w/w |
|---|---|---|
| 1 | Vistanex LMMH | 50 |
| 2 | Vistanex L80 | 24 |
| 3 | Eastoflex E-1003 | 24 |
| 4 | Whitemoor WOM14 | 2 |

This formulation lacked the high surface area stabiliser.

1 mm samples of this material had inferior cohesive strength compared to examples 1-6 and displayed a tendency to leg when peeled from the skin, leaving the feel of a waxy residue.

### Comparative Example 2

In an identical manner to that described in Example 1 above, the following mixture was mixed in a Z-blade mixer at 100° C.

| | Ingredient | % w/w |
|---|---|---|
| 1 | Vistanex LMMH | 65 |
| 2 | Vistanex L80 | 16 |
| 3 | Eastoflex E-1003 | 16 |
| 4 | Whitemoor WOM14 | 3 |

This formulation lacked the high surface area stabiliser.

1 mm samples of this material had inferior cohesive strength compared to Examples 1-6 and displayed a tendency to leg when peeled from the skin, leaving the feel of a waxy residue.

### Comparative Example 3

In an identical manner to that described in Example 1 above, the following mixture was mixed in a Z-blade mixer at 100° C.

| | Ingredient | % w/w |
|---|---|---|
| 1 | Vistanex LMMH | 80 |
| 2 | Vistanex L80 | 9 |
| 3 | Eastoflex E-1003 | 9 |
| 4 | Whitemoor WOM14 | 2 |

This formulation lacked the high surface area stabiliser.

1 mm samples of this material had inferior cohesive strength compared to Examples 1-6 and displayed a tendency to leg when peeled from the skin, leaving the feel of a waxy residue.

Comparative Examples 1-3 thus demonstrate that a PSA composition without a high surface area stabiliser have poor adhesive strength and lack the necessary shear adhesion resulting in the retention of a waxy residue on the skin after removal.

### EXAMPLE 6

The inclusion of a material having anti-bacterial properties within the PSA composition is beneficial for certain applications such as wound dressings. Certain anti-bacterial materials are coloured and we have found that the inclusion of such a material greatly assists in observation of mixing and compatibility of the PIB and poly-α-olefin phases of the PSA composition. This is illustrated in the present Examples and Examples 7-9 with the inclusion of X-static fibres (fibres treated with silver/silver ions to generate an anti-bacterial material that are available from Nobel Fibre Technologies of Pennsylvania U.S.A.) and Povidone-iodine USP (a complex between poly N-vinyl pyrrolidone and iodine, available from ISP Technologies of New Jersey, U.S.A.).

Preparation of the following composition was carried out.

| | Ingredient | % w/w |
|---|---|---|
| 1 | Vistanex LMMH | 37.6 |
| 2 | Vistanex L80 | 14.3 |
| 3 | Eastoflex E-1003 | 14.3 |
| 4 | Avicel PH101 | 24.3 |
| 5 | X-Static short staple | 9.5 |

X-static short staple is a nylon fibre treated with silver/silver ions.

The Z-blade mixer was pre-heated by an oil jacket to 90° C. and the blades coated with 10-15% of the Avicel PH101. The listed ingredients were added sequentially to the mixer over 20-25 minutes and mixing was allowed to continue for 2 hours at 90° C. After this time the mixture was ejected from the Z-blade mixer and samples were pressed out between pieces of siliconised paper at 110° C. to produce samples of 1 mm thickness. The sample was photographed taken using a digital camera (Olympus model c-900 zoom) and the image is shown in FIG. 1. The presence of the X-static fibre causes the pressed out sheet of pressure sensitive adhesive to be black. As seen from the photograph in FIG. 1 the colour is uniform over the whole sample indicating that the amorphous poly-α-olefin and PIB phases of the material are fully mixed and compatible.

### EXAMPLE 7

In an identical manner to that described in Example 6 above, the following mixture was mixed in a Z-blade mixer at 90° C.

| | Ingredient | % w/w |
|---|---|---|
| 1 | Vistanex LMMH | 37.1 |
| 2 | Vistanex L80 | 13.8 |
| 3 | Eastoflex E-1003 | 13.8 |
| 4 | Hi-Sil 233 | 23.8 |
| 5 | X-Static short staple | 9.0 |
| 6 | Whitemoor WOM14 | 2.5 |

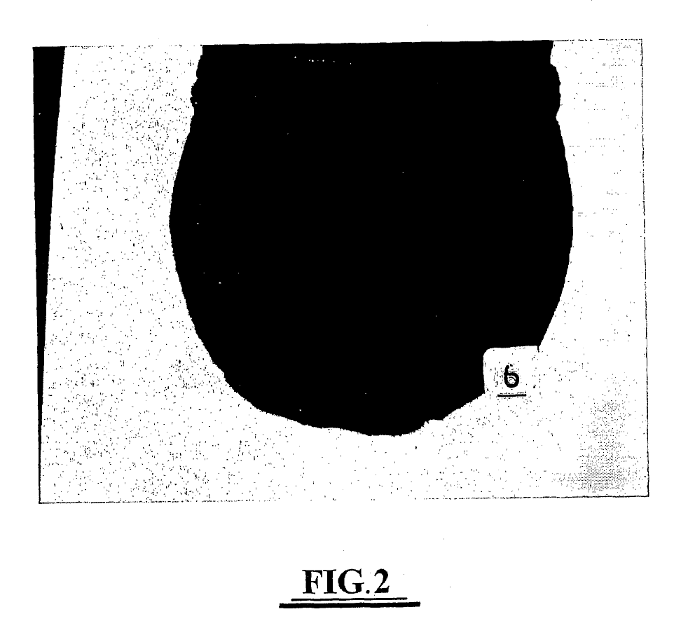

The pressed out sheet sample was found to be homogeneously pigmented as shown by the photograph in FIG. 2. As seen from the photograph in FIG. 2 the colour is uniform over the whole sample indicating that the amorphous poly-α-olefin and PIB phases of the material are fully mixed and compatible.

### EXAMPLE 8

In an identical manner to that described in Example 6 above, the following mixture was mixed in a Z-blade mixer at 90° C.

| | Ingredient | % w/w |
|---|---|---|
| 1 | Vistanex LMMH | 30.2 |
| 2 | Vistanex L80 | 19.7 |
| 3 | Eastoftex E-1003 | 13.8 |
| 4 | Justfiber C40 | 23.8 |
| 5 | X-Static short staple | 9.0 |
| 6 | Whitemoor WOM14 | 2.5 |

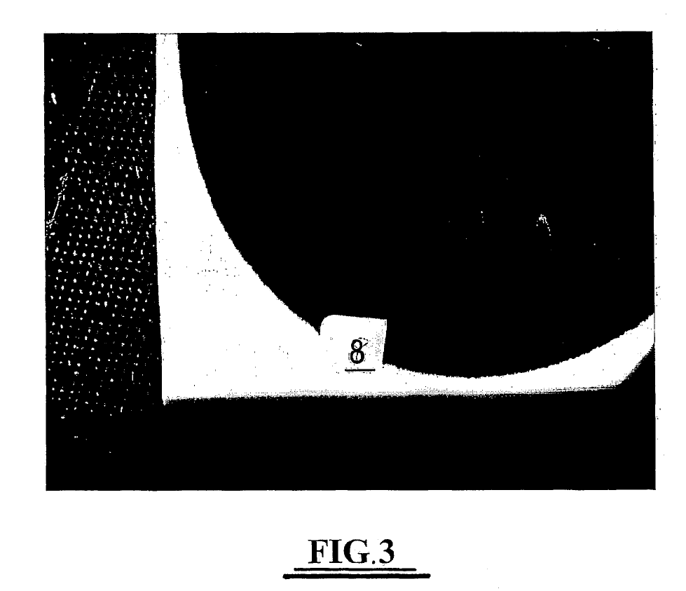

The pressed out sheet sample was found to be homogeneously pigmented as shown by the photograph in FIG. 3. As seen from the photograph in FIG. 3 the colour is uniform over the whole sample indicating that the amorphous poly-α-olefin and PIB phases of the material are fully mixed and compatible. Samples of the pressed out sheet of pressure sensitive adhesive were subjected to sterilisation by gamma irradiation (25 kilogreys) and were found to retain good integrity and tack after sterilisation this treatment.

### EXAMPLE 9

In an identical manner to that described in Example 6 above, the following mixture was mixed in a Z-blade mixer at 90° C.

| | Ingredient | % w/w |
|---|---|---|
| 1 | Vistanex LMMH | 31.7 |
| 2 | Vistanex L80 | 21.9 |
| 3 | Eastoflex E-1003 | 14.7 |
| 4 | Justfiber C40 | 25.1 |
| 5 | Povidone-Iodine | 6.6 |

Povidone-iodine is a complex of polyvinyl pyrrolidone and iodine.

The pressed out sheet sample was found to be homogeneously pigmented reddish brown, indicating that the amorphous poly-α-olefin and PIB phases of the material are fully mixed and compatible.

### Comparative Example 4

In an identical manner to that described in Example 6 above, the following mixture was mixed in a Z-blade mixer at 90° C.

| | Ingredient | % w/w |
|---|---|---|
| 1 | Vistanex LMMH | 46.6 |
| 2 | Vistanex L80 | 29.6 |
| 3 | EastoflexE-1003 | 14.3 |
| 4 | X-Static short staple | 9.5 |

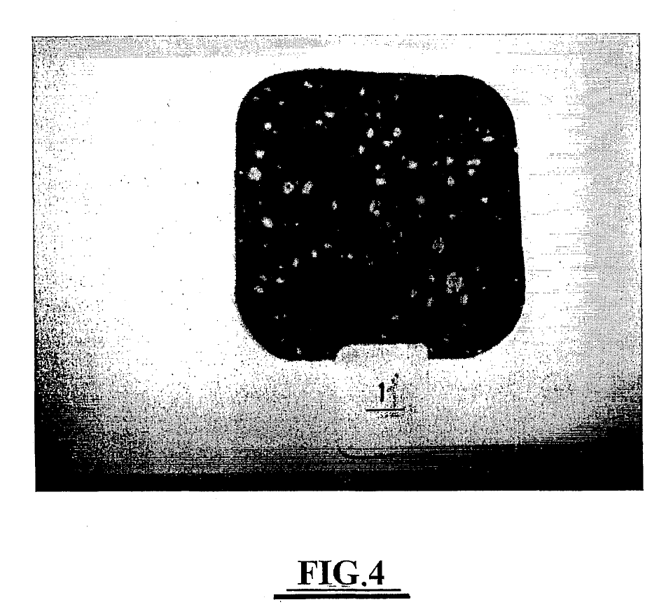

The pressed out sheet samples were found to contain islands of clear material as seen from the photograph in FIG. 4. Clearly the non-uniform nature of the sample indicates incomplete mixing and separation of the amorphous poly-α-olefin and PIB phases of the material.

### Comparative Example 5

In an identical manner to that described in Example 6 above, the following mixture was mixed in a Z-blade mixer at 90° C.

| | Ingredient | % w/w |
|---|---|---|
| 1 | Vistanex LMMH | 47.6 |
| 2 | Vistanex L80 | 14.3 |
| 3 | Eastoflex E-1003 | 14.3 |
| 4 | Avicel PH101 | 14.3 |
| 5 | X-Statie short staple | 9.5 |

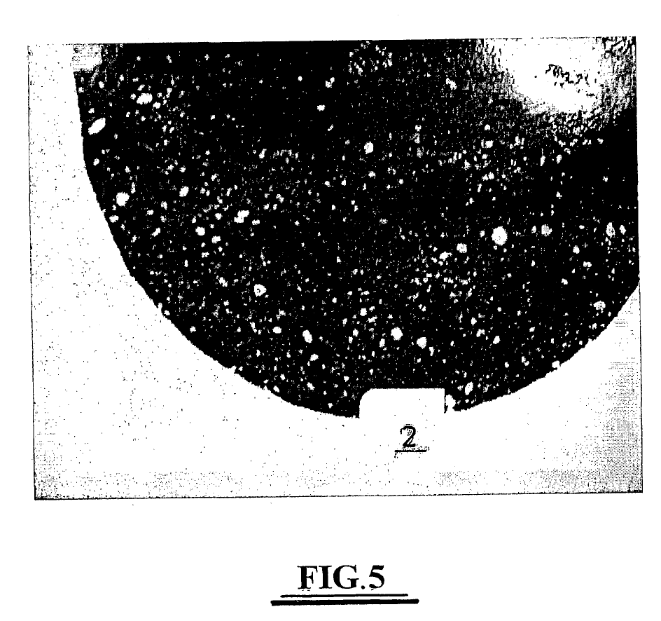

The pressed out sheet samples were found to contain islands of clear material as seen from the photograph in FIG. 5. Clearly the non-uniform nature of the sample indicates incomplete mixing and separation of the amorphous poly-α-olefin and PIB phases of the material. It is therefore seen that the level of Avicel within formulation was insufficient to bring about compatibility of the 2 phases.

### EXAMPLE 10

To demonstrate the suitability of pressure sensitive adhesives of the type described in the invention as vehicles for the delivery of pharmaceuticals the non-steroid anti-inflammatory drug Ibuprofen was loaded into various formulations as described in the present Example and Examples 11-12 below. A particular drawback to using pressure sensitive adhesives to deliver active molecules that have been dispersed within such a vehicle is the capability of the drug to crystallise as a solid at the surface of the pressure sensitive adhesive thereby causing problems with shelf-life and predictability of drug delivery.

In an identical manner to that described in Example 6 above, the following mixture was mixed in a Z-blade mixer at 90° C.

| | Ingredient | % w/w |
|---|---|---|
| 1 | Vistanex LMMH | 41.9 |
| 2 | Vistanex L80 | 14.3 |
| 3 | Eastoflex E-1003 | 14.3 |
| 4 | Avicel PH101 | 24.8 |
| 5 | Ibuprofen | 4.7 |

Ibuprofen is 2-(4-isobutylphenyl)-propionic acid (supplied by Albemerle Inc, Louisiana USA)

Samples of the pressed out sheet were taken and discs cut from them to measure the diffusion of Ibuprofen from them. The diffuision of Ibuprofen from the pressure sensitive adhesive vehicle was carried out using a Franz cell with a silicone rubber membrane to mimic the skin barrier and 0.9% w/w saline solution at 37° C. as a receiver fluid. The concentration of Ibuprofen in the receiver fluid was determined after 4 and 24 hours using HPLC chromatography. After 4 hours the pressure sensitve adhesive was found to have delivered 83 μg of Ibuprofen per cm² of vehicle and after 24 hours 254 μg of Ibuprofen per cm² of vehicle. Samples were stored at room temperature for a period of 3 months and after this time were checked for bloom of Ibuprofen to the surface of the pressure sensitive sheet by optical microscopy. No evidence of bloom of Ibuprofen was found after this time. To further investigate further the potential of Ibuprofen to bloom to the surface of this formulation, samples that had been stored for 3 months were further aged by being placed at −4° C. for 72 hours to encourage surface crystallisation of the drug. Again optical microscopy revealed no evidence of surface bloom of Ibuprofen.

### EXAMPLE 11

In an identical manner to that described in Example 6 above, the following mixture was mixed in a Z-blade mixer at 90° C.

| | Ingredient | % w/w |
|---|---|---|
| 1 | Vistanex LMMH | 41.9 |
| 2 | Vistanex L80 | 14.3 |
| 3 | Eastoflex E-1003 | 14.3 |
| 4 | Hi-Sil 233 | 24.8 |
| 5 | Ibuprofen | 4.7 |

The delivery of Ibuprofen from this formulation was determined in an identical manner to that described in Example 10. After 4 hours the pressure sensitive adhesive was found to have delivered 113 μg of Ibuprofen per cm² of vehicle and after 24 hours 240 μg of Ibuprofen per cm² of vehicle. The potential of Ibuprofen to bloom to the surface of this formulation was checked by the same method described in Example 10. Again optical microscopy revealed no surface bloom after 3 months storage at room temperature or a further 72 hours refrigeration at −4° C.

### EXAMPLE 12

In an identical manner to that described in Example 6 above, the following mixture was mixed in a Z-blade mixer at 90° C.

| | Ingredient | % w/w |
|---|---|---|
| 1 | Vistanex LMMH | 41.9 |
| 2 | Vistanex L80 | 14.3 |
| 3 | Eastoflex E-1003 | 14.3 |
| 4 | Justfiber C40 | 24.8 |
| 5 | Ibuprofen | 4.7 |

The delivery of Ibuprofen from this formulation was determined in an identical manner to that described in Example 10. After 4 hours the pressure sensitive adhesive was found to have delivered 75 μg of Ibuprofen per cm² of vehicle and after 24 hours 169 μg of Ibuprofen per cm² of vehicle. The potential of Ibuprofen to bloom to the surface of this formulation was checked by the same method described in Example 10. Again optical microscopy revealed no surface bloom after 3 months storage at room temperature or a further 72 hours refrigeration at −4° C.

### Comparative Example 6

In an identical manner to that described in Example 6 above, the following mixture was mixed in a Z-blade mixer at 90° C.

| | Ingredient | % w/w |
|---|---|---|
| 1 | Vistanex LMMH | 21.5 |
| 2 | Vistanex L80 | 7.5 |
| 3 | Durotak H1540 | 13.7 |
| 4 | CMC Blanose 7H4XF | 28.3 |

CMC Blanose 7H4XF is carboxymethyl cellulose (supplied by Hercules Inc.) Durotak H1540 is an acrylic pressure sensitive adhesive (supplied by National Starch Ltd.)

The composition of this comparative Example does not include a poly-α-olefin.

The delivery of Ibuprofen from this formulation was determined in an identical manner to that described in Example 10. After 4 hours the pressure sensitive adhesive was found to have delivered 59 μg of Ibuprofen per cm² of vehicle and after 24 hours 250 μg of Ibuprofen per cm² of vehicle. The potential of Ibuprofen to bloom to the surface of this formulation was checked by the same method described in Example 10. After 3 months storage at room temperature surface crystallisation was identifiable by the naked eye and subsequent analysis by HPLC verified that the crystalline material was Ibuprofen. After a further 72 hours refrigeration of the sample at −4° C., the surface crystallisation of Ibuprofen was easily identified by visual examination. While the formulation contained a high surface area filler such as Justfiber C40, there was clearly insufficient to prevent surface bloom of Ibuorofen.

Thus the Examples 10-12 and Comparative Example 6 clearly demonstrate tendency of a non-steroid anti-inflammatory drug such as Ibuprofen to bloom and undergo surface crystallisation is clearly reduced in a pressure sensitive adhesive formulation containing a high surface area filler of the type described in the present invention.

1. A pressure sensitive adhesive composition comprising
(a) a tacky, amorphous poly-α-olefin which is a block copolymer of ethylene and propene, butene, pentene or hexene,
(b) a poly-iso-butylene, and
(c) a compatibilising high surface area stabiliser.

2. A pressure sensitive adhesive composition according to claim 1, wherein the high area stabiliser is insoluble in components of the PSA composition.

3. A pressure sensitive adhesive composition according to claim 1 or 2, wherein the high surface area stabiliser is a fibrous material.

4. A pressure sensitive adhesive composition according to claim 3, wherein the (surface area) bulk density of the fibrous material is such that 1 gram of material occupies 2-15 cm³.

5. A pressure sensitive adhesive composition according to claim 4, wherein the (surface area) bulk density of the fibrous material is such that 1 gram of material occupies 3-10 cm³.

6. A pressure sensitive adhesive composition according to any one of claims 3 to 5, wherein the fibre strands have a length of 30-250 μm.

7. A pressure sensitive adhesive composition according to claim 6, wherein the fibre strands have a length of 50-150 μm.

8. A pressure sensitive adhesive composition according to any one of claims 3 to 7, wherein the fibre strands have a cross-section of 5-25 μm.

9. A pressure sensitive adhesive composition according to any one of claims 3 to 8, wherein the fibrous material constitutes from 10-60% of the weight of the composition.

10. A pressure sensitive adhesive composition according to claim 9, wherein the fibrous material constitutes from 15-55% by weight of the composition.

11. A pressure sensitive adhesive composition according to claim 10, wherein the fibrous material constitutes 20-50% by weight of the composition.

12. A pressure sensitive adhesive composition according to any one of claims 3 to 11, wherein the fibrous material comprises cellulosic fibres.

13. A pressure sensitive adhesive composition according any one of claims 3 to 12, wherein the fibrous material is in the form of a single fibre strands.

14. A pressure sensitive adhesive composition according to any of the preceding claims, wherein the high surface area stabiliser comprises particulate material.

15. A pressure sensitive adhesive composition according to claim 14, wherein the particulate material has a particle size in the range of 10-500 μm.

16. A pressure sensitive adhesive composition according to claim 15, wherein the particulate material has a particle size in the range of 30-100 μm.

17. A pressure sensitive adhesive composition according to any of claims 14 to 16, wherein the particulate material constitutes from 20-40% of the weight of the composition.

18. A pressure sensitive adhesive composition according to claim 17, wherein the particulate material constitutes from 20-30% of the weight of the composition.

19. A pressure sensitive adhesive composition according to any one of claims 14 to 18, wherein the particulate material is chosen from the group comprising silica and micro-crystalline cellulose.

20. A pressure sensitive adhesive composition according to any of the preceding claims, wherein the mean molecular mass of the PIB is 150,000 to 250,000.

21. A pressure sensitive adhesive composition according to claim 20, wherein the mean molecular mass figure is obtained from a single PIB polymer.

22. A pressure sensitive adhesive composition according to claim 20, wherein the mean molecular mass figure is obtained from a mixture of different PIB polymers.

23. A pressure sensitive adhesive composition according to claim 22, wherein the mixture of different PIB polymers includes low molecular weight PIB and medium molecular weight PIB.

24. A pressure sensitive adhesive composition according to claim 23, wherein the proportion of low molecular weight PIB is between 70-95% of the PIB content.

25. A pressure sensitive adhesive composition according to any of the preceding claims, wherein the PIB constitutes from 40-65% of the weight of the composition.

26. A pressure sensitive adhesive composition according to claim 25, wherein the PIB constitutes from 50-60% of the weight of the composition.

27. A pressure sensitive adhesive composition according to any one of claims 1 to 26, wherein the poly-α-olefin is a block copolymer of ethylene and propene.

28. A pressure sensitive adhesive composition according to any of the preceding claims, wherein the poly-α olefin constitutes from 5-25% of the weight of the composition.

29. A pressure sensitive adhesive composition according to claim 28, wherein the poly-α olefin constitutes from 10-20% of the weight of the composition.

30. A pressure sensitive adhesive composition according to any of the preceding claims, wherein the composition contains an extender.

31. A pressure sensitive adhesive composition according to claim 30, wherein the extender constitutes from 2-5% of the composition by weight.

32. A pressure sensitive adhesive composition according to claim 30 or 31, wherein the extender is a mineral oil.

33. A pressure sensitive adhesive composition according to any of the preceding claims, wherein the composition comprises an additive selected from the groups comprising pharmaceuticals, emollients, vitamins, herbal extracts, water soluble polymers, such as polysaccharides, including gelatin, pectin and carboxymethyl cellulose.

34. A pressure sensitive adhesive composition according to any of the preceding claims, wherein the adhesive is used in transdermal drug delivery, attachment devices for ostomy/stoma bags and wound dressing applications.

35. A PSA composition having the following composition:

| | |
|---|---|
| Low molecular weight PIB | 20-50 wt % |
| Medium molecular weight PIB | 10-20 wt % |
| A tacky, amorphous poly-α olefine | |
| which is a block copolymer of ethylene | |
| and propene, butene, pentene or hexane. | 10-20 wt % |
| High surface area stabiliser | 20-50 wt % |

36. A method of preparing a pressure sensitive adhesive composition according to any one of claims 1 to 35 comprising admixing a tacky, amorphous poly-α olefine which is a block copolymer of ethylene and propene, butene, pentene or hexene, a poly-iso-butylene and a high surface area stabiliser.

37. A method according to claim 36, wherein the method of preparation is carried out at about the softening temperature of the poly-α-olefin.

38. A method according to claim 36 or 37, comprising adding the specific components as separate additions to an appropriate mixing device and thoroughly mixing.

39. A method according to claim 36, 37 or 38, wherein the composition is mixed in a Z-blade mixer.

40. A method according to any one of claims 36 to 39, wherein the mixing step is effected for 20-30 minutes following the addition of each ingredient and for about 1 hour after all the ingredients have been added.
